(19) United States
(12) Patent Application Publication
(10) Pub. No.: US 2025/0321587 A1
(43) Pub. Date: Oct. 16, 2025

(54) INFORMATION PROCESSING APPARATUS AND INFORMATION PROCESSING METHOD

(71) Applicant: SONY GROUP CORPORATION, TOKYO (JP)

(72) Inventor: TORU IGAMI, TOKYO (JP)

(21) Appl. No.: 18/873,403

(22) PCT Filed: May 29, 2023
(86) PCT No.: PCT/JP2023/019860

§ 371 Date: Dec. 10, 2024

(30) Foreign Application Priority Data
Jun. 17, 2022 (JP) 2022097729

(51) Int. Cl. G05D 1/617; G05D 109/20; G08G 5/80

(52) U.S. Cl. CPC G05D 1/617; G08G 5/80; G05D 2109/20

(57) ABSTRACT

The present technology relates to an information processing apparatus and an information processing method that allow a user to easily check the safety of the flight area of a flying object. An information processing apparatus includes: an output control unit that controls an output of safety information that is information based on first flying object information including information relating to a surrounding environment of one or more first flying objects detected by the one or more first flying objects, the safety information being information relating to safety of a flight area in which a second flying object flies. The present technology is applicable to, for example, a server that manages an operation of a drone.

### TECHNICAL FIELD

The present technology relates to an information processing apparatus and an information processing method, and particularly to an information processing apparatus and an information processing method that allow a user to easily check the safety of the flight area of a flying object.

### BACKGROUND ART

In the past, a technology in which a wind vector within a region is identified using measured values from a plurality of aircrafts, a three-dimensional wind condition map is created on the basis of the identified wind vector, and a flight plan of the aircraft is created using the three-dimensional wind condition map has been proposed (see, for example, Patent Literature 1).

### CITATION LIST

### Patent Literature

Patent Literature 1: Japanese Patent Application Laid-open No. 2019-89538

### DISCLOSURE OF INVENTION

### Technical Problem

However, the three-dimensional wind condition map of the invention described in Patent Literature 1 is intended for creating a flight plan of an aircraft and is not intended to be presented to a user. Therefore, in the invention described in Patent Literature 1, it is difficult for a flying object such as a drone to check the safety of the flight area.

The present technology has been made in view of the above-mentioned circumstances and it is an object thereof to allow a user to easily check the safety of the flight area of a flying object such as a drone.

### Solution to Problem

An information processing apparatus according to an aspect of the present technology includes: an output control unit that controls an output of safety information that is information based on first flying object information including information relating to a surrounding environment of one or more first flying objects detected by the one or more first flying objects, the safety information being information relating to safety of a flight area in which a second flying object flies.

An information processing method according to an aspect of the present technology includes: controlling, by an information processing apparatus, an output of safety information that is information based on flying object information including information relating to a surrounding environment of one or more first flying objects detected by the one or more first flying objects, the safety information being information relating to safety of a flight area in which a second flying object flies.

In an aspect of the present technology, safety information that is information based on flying object information including information relating to a surrounding environment of one or more first flying objects detected by the one or more first flying objects is output, the safety information being information relating to safety of a flight area in which a second flying object flies.

### BRIEF DESCRIPTION OF DRAWINGS

FIG. 1 is a diagram for describing an overview of the present technology.

FIG. 2 is a block diagram showing an embodiment of a flight management system to which the present technology is applied.

FIG. 3 is a block diagram showing a configuration example of a function of a drone.

FIG. 4 is a block diagram showing a configuration example of a function of a controller.

FIG. 5 is a block diagram showing a configuration example of a function of a mobile device.

FIG. 6 is a block diagram showing a configuration example of a function of a management server.

FIG. 7 is a flowchart for describing processing of a flight management system.

FIG. 8 is a flowchart for describing details of risk detection processing.

FIG. 9 is a flowchart for describing details of risk prediction processing.

FIG. 10 is a diagram showing a display example of safety information of the mobile device.

FIG. 11 is a diagram showing a display example of safety information of the mobile device.

FIG. 12 is a diagram showing a display example of safety information of the mobile device.

FIG. 13 is a diagram showing a display example of safety information of the mobile device.

FIG. 14 is a diagram showing an example of an output of safety information of the controller.

FIG. 15 is a diagram showing a display example of safety information of the drone.

FIG. 16 is a diagram showing a display example of safety information of the mobile device.

FIG. 17 is a block diagram showing a configuration example of a computer.

### MODE(S) FOR CARRYING OUT THE INVENTION

An embodiment for carrying out the present technology will be described below. The description will be made in the following order.
1. Embodiment
2. Modified example
3. Others

### 1. Embodiment

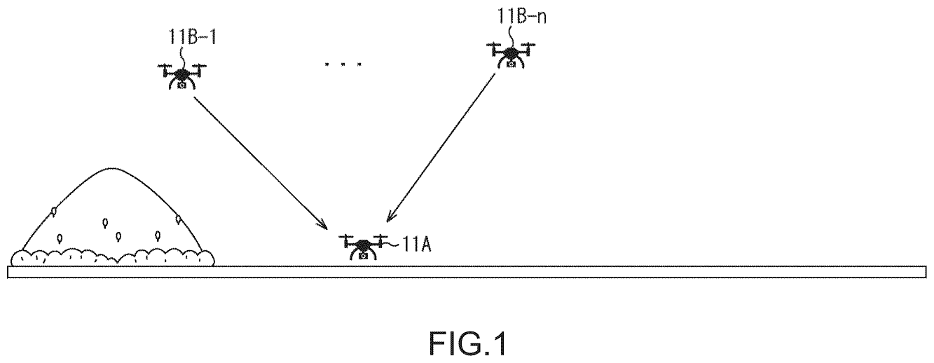

An embodiment of the present technology will be described with reference to FIG. 1 to FIG. 16.

### Overview of Present Technology

First, an overview of the present technology will be described with reference to FIG. 1.

In order to fly a drone safely, it is desirable to secure the safety of the flight area of the drone in advance. Note that the flight area includes not only an area where the drone actually flies but also an area where the drone is going to fly.

In this regard, for example, a user secures the safety of the flight area by checking the geomagnetic state, wind state, GNSS signal reception state, and the like at the takeoff point where he/she is before the drone flies.

However, the environment in the vicinity of the ground where the user is and the environment in the flight area where the drone actually flies differ in some cases. For this reason, currently, it is necessary to actually fly the drone and then finally check the environment in the flight area to determine the safety. Therefore, the fact that the flight area is dangerous comes out after flying the drone in some cases.

On the other hand, as shown in FIG. 1, the present technology allows a user to easily check the safety of the flight area of a drone 11A, which is operated by him/her, on the basis of pieces of information from drones 11B-1 to 11B-n around the drone 11A. The drones 11B-1 to 11B-n are, for example, drones that are already flying in the airspace or at the height where the drone 11A is going to fly.

Note that hereinafter, in the case where there is no need to individually distinguish between the drones 11B-1 to 11B-n, they will be referred to simply as a drone 11B. Hereinafter, in the case where there is no need to distinguish between the drone 11A and the drone 11B, they will be referred to simply as a drone 11. Hereinafter, the drone 11A will be referred to also as an own device. Hereinafter, the drone 11B other than the drone 11A will be referred to also as another device.

### Configuration Example of Flight Management System 1

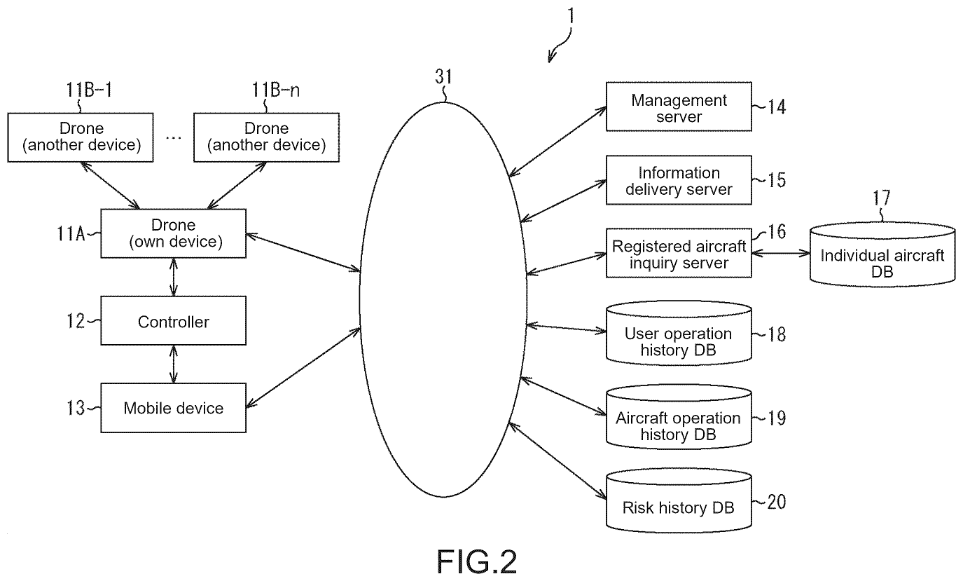

Next, a configuration example of a flight management system 1 to which the present technology is applied will be described with reference to FIG. 2. The flight management system 1 is a system that detects and predicts the safety of the flight area of the drone 11A, presents information indicating the safety of the flight area to a user, and controls the flight operation of the drone 11A.

The flight management system 1 includes, in addition to the above-mentioned drone 11A and drones 11B-1 to 11B-n, a controller 12, a mobile device 13, a management server 14, an information delivery server 15, a registered aircraft inquiry server 16, an individual aircraft DB (database) 18, a user operation history DB (database) 18, an aircraft operation history DB (database) 19, and a risk history DB (database) 20.

The drone 11A, each drone 11B, the controller 12, the mobile device 13, the management server 14, the information delivery server 15, the registered aircraft inquiry server 16, the user operation history DB 18, the aircraft operation history DB 19, and the risk history DB 20 are connected to each other via a network 31 and are capable of communicating with each other. The network 31 includes a network such as the Internet and a mobile phone network, a base station, an access point, and the like. Note that illustration of the connection between each drone 11B and the network 31 is omitted.

Note that this diagram is a diagram focusing on the drone 11A operated by a user and illustration of the configuration of each drone 11B is omitted. For example, actually, a controller and a mobile device are provided in each drone 11B. Further, although description is omitted, each drone 11B is also capable of executing processing similar to that executed by the drone 11A described below.

The drone 11A is capable of directly performing wireless communication with each drone 11B using a predetermined communication method. As the communication method between the drone 11A and each drone 11B, for example, a short-range wireless communication method such as Bluetooth (registered trademark) or a direct broadcast method using Wi-Fi Beacon or the like is used.

The drone 11A is capable of directly performing wireless communication with the controller 12 using a predetermined communication method. As the communication method between the drone 11A and the controller 12, for example, a spread spectrum method in a 2.4 GHz band is used.

The drone 11A is capable of connecting to the network 31 using, for example, wireless communication such as Wi-Fi or mobile communication such as 4G and 5G. For this reason, the drone 11A is capable of communicating with each drone 11B, the mobile device 13, the management server 14, the information delivery server 15, the registered aircraft inquiry server 16, and the like via the network 31.

The controller 12 includes, for example, a proportional system. The controller 12 is capable of directly performing wireless communication with the drone 11A as described above and is used to remotely control the drone 11A.

The controller 12 is capable of directly performing wireless communication with the mobile device 13 using a predetermined communication method. As the communication method between the controller 12 and the mobile device 13, for example, a short-range wireless communication method such as Bluetooth (registered trademark) is used.

The mobile device 13 includes, for example, a smartphone. The mobile device 13 is capable of connecting to the network 31 using wireless communication such as Wi-Fi or mobile communication such as 4G and 5G. For this reason, the mobile device 13 is capable of communicating with each drone 11, the management server 14, the information delivery server 15, the registered aircraft inquiry server 16, and the like via the network 31.

Note that an example of the case where the mobile device 13 performs wireless communication with the drone 11A using Wi-Fi via the network 31 (e.g., access point) will be described below.

The mobile device 13 is capable of, for example, remotely controlling the drone 11A or outputting information indicating the state of the drone 11A and the safety of the flight area of the drone 11 by executing a predetermined application.

The management server 14 is, for example, a server that manages the operation of each drone 11. The management server 14 generates information indicating the safety of the flight area of the drone 11A (hereinafter, referred to as safety information) on the basis of, for example, information from each drone 11. The management server 14 transmits the safety information to the drone 11A and the mobile device 13 via the network 31.

In response to this, the drone 11A outputs safety information to the user on the basis of the safety information from the management server 14. The drone 11A controls the flight operation on the basis of the safety information.

The mobile device 13 outputs safety information to the user on the basis of the safety information from the management server 14. The mobile device 13 remotely controls the flight operation of the drone 11 by transmitting an operation command or a control parameter to the drone 11 on the basis of the safety information. The mobile device 13 transmits the safety information to the controller 12.

The controller 12 outputs safety information to the user on the basis of the safety information from the mobile device 13. The controller 12 remotely controls the flight operation of the drone 11 by transmitting an operation command or a control parameter to the drone 11 on the basis of the safety information.

Further, the management server 14 remotely controls the flight operation of the drone 11 by transmitting an operation command or a control parameter to the drone 11A via the network 31 on the basis of the safety information.

The information delivery server 15 delivers various types of information relating to the flight area of the drone 11A (hereinafter, referred to as delivery information). The delivery information includes, for example, weather information.

The registered aircraft inquiry server 16 provides registration information of each drone 11 by responding to an inquiry about information relating to the drone 11 from the management server 14 or the like using the individual aircraft DB 17.

The individual aircraft DB 17 is a database that stores registration information relating to each drone 11. The registration information includes, for example, a remote ID, type, method, manufacturer, serial number, weight classification, and personal information such as an operator (e.g., an owner or a user) of each drone 11, and whether or not it has been modified.

The user operation history DB 18 is a database that stores the operation history of the drone 11 of each user. The operation history of the drone 11 of each user includes, for example, the number of flights of the drone 11 of each user, an operated aircraft history, and a risk history of the operation area. The operated aircraft history indicates, for example, the aircraft history of the drone 11 operated by the user. For example, the operated aircraft history indicates what level aircraft from small to large each user has operated. The risk history of the operation area indicates, for example, a risk history of the area where the user has operated the drone 11. For example, the risk history of the operation area indicates how dangerous the location is for each user to have operated the drone 11.

The aircraft operation history DB 19 is a database that stores an operation history of each drone 11. The operation history of each drone 11 includes, for example, the number of flights of each drone 11, an error detection history of each drone 11 by self-diagnosis, and a repair history.

The risk history DB 20 is a database that stores a risk history of each point. The risk history of each point includes, for example, the position and date and time when the risk was detected, and information regarding a risk for each risk factor and the integrated risk.

Further, the risk history DB 20 stores a risk map generated by the management server 14. As will be described below in detail, the risk map is a map indicating the spatial distribution of risks for each risk factor and the integrated risks.

Here, the risk factor is a factor that can have an adverse effect on the flight of the drone 11. For example, the risk factor incudes a geomagnetic state, a wind state (a wind speed, a wind direction, and the like), illuminance, a GNSS signal reception state, a communication state of wireless communication, and the like.

### Configuration Example of Drone 11

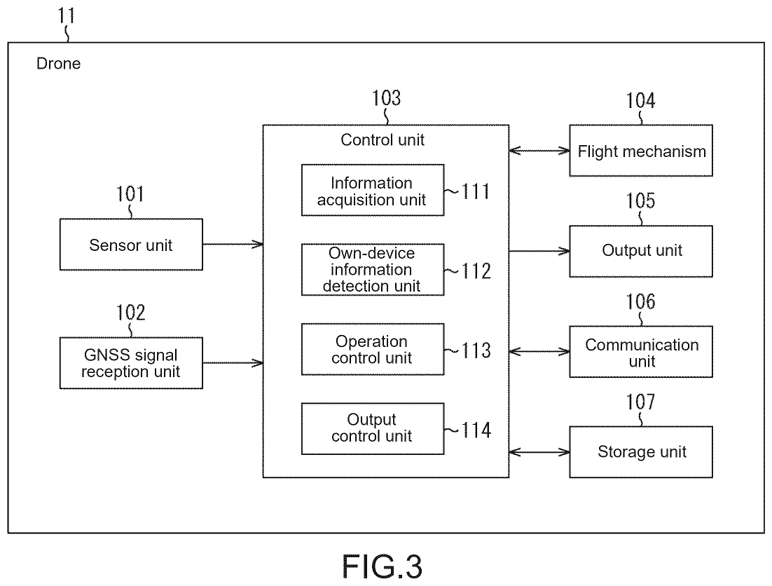

FIG. 3 shows a configuration example of the drone 11.

The drone 11 includes a sensor unit 101, a GNSS signal reception unit 102, a control unit 103, a flight mechanism 104, a communication unit 106, and a storage unit 107.

The sensor unit 101 includes various sensors that detect the state of the drone 11 or the state of the surroundings of the drone 11. For example, the sensor unit 101 includes an image sensor such as a camera, a stereo camera, and a depth sensor (e.g., ToF (Time of Flight) sensor), an anemometer, a geomagnetic sensor, and an IMU (Inertial Measurement Unit). Each sensor of the sensor unit 101 supplies sensor data indicating the detection result to the control unit 103.

The GNSS signal reception unit 102 receives a GNSS signal from a GNSS satellite and supplies the received GNSS signal to the control unit 103.

The control unit 103 includes a processor such as a CPU (Central Processing Unit), a memory, and the like. The control unit 103 executes a predetermined program to controls the respective units of the drone 11 and execute various types of processing. The control unit 103 includes an information acquisition unit 111, an own-device information detection unit 112, an operation control unit 113, and an output control unit 114.

The information acquisition unit 111 acquires various types of information from the outside via the communication unit 106. For example, the information acquisition unit 111 acquires information relating to each drone 11B from the drone 11B (hereinafter, referred to as another-device information). For example, the information acquisition unit 111 acquires safety information from the management server 14.

The own-device information detection unit 112 detects the states of the drone 11 and the surroundings of the drone 11 on the basis of sensor data from the sensor unit 101, a GNSS signal from the GNSS signal reception unit 102, and information indicating the state of the flight mechanism 104 from the flight mechanism 104. The own-device information detection unit 112 generates own-device information indicating the states of the drone 11 and the surroundings of the drone 11.

The operation control unit 113 controls the flight operation of the drone 11 by controlling the flight mechanism 104 on the basis of own-device information, safety information, and an operation command and control parameter received from the outside (e.g., the controller 12, the mobile device 13, or the management server 14) via the communication unit 106.

The output control unit 114 controls an output of various types of information from the output unit 105 (e.g., visual information and auditory information). For example, the output control unit 114 controls an output of safety information from the output unit 105.

The flight mechanism 104 is a mechanism for flying the drone 11. The flight mechanism 104 includes, for example, a propeller, a motor that causes the propeller to rotate, and the like. The flight mechanism 104 is driven under the control of the operation control unit 113 to fly the drone 11.

The output unit 105 includes various output devices that output visual information or auditory information. For example, the output unit 105 includes a display device, an audio output device, and the like. The output unit 105 outputs various types of information under the control of the output control unit 114.

The communication unit 106 includes various communication devices and performs wireless communication with a different device using a predetermined communication method. For example, the communication unit 106 directly perform wireless communication with the drone 11B and the controller 12. For example, the communication unit 106 communicates with the drone 11B, the mobile device 13, the management server 14, the information delivery server 15, the registered aircraft inquiry server 16, and the like via the network 31.

The storage unit 107 includes, for example, a non-volatile memory and stores various types of information necessary for the processing of the drone 11.

### Configuration Example of Controller 12

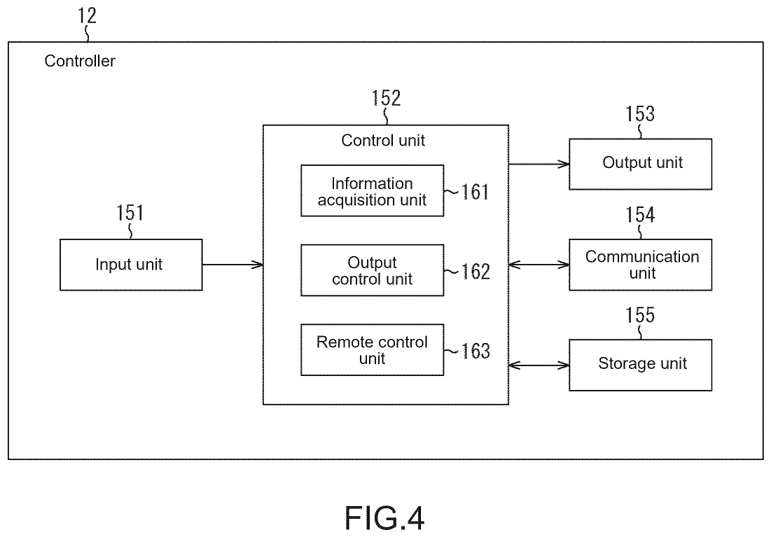

FIG. 4 shows a configuration example of a function of the controller 12.

The controller 12 includes an input unit 151, a control unit 152, an output unit 153, a communication unit 154, and a storage unit 155.

The input unit 151 includes various input devices and operation devices and is used to input various types of information and operate the controller 12. The input unit 151 supplies input information input using the input device or the operation device to the control unit 152.

The control unit 152 includes a processor such as a CPU, a memory, and the like. The control unit 152 executes a predetermined program to control the respective units of the controller 12 and execute various types of processing. The control unit 152 include an information acquisition unit 161, an output control unit 162, and a remote control unit 163.

The information acquisition unit 161 acquires various types of information from the outside via the communication unit 154. For example, the information acquisition unit 161 acquires own-device information from the drone 11A. For example, the information acquisition unit 161 acquires safety information from the mobile device 13.

The output control unit 162 controls an output of various types of information from the output unit 153 (e.g., visual information, auditory information, and haptic sensation information). For example, the output control unit 162 controls an output of safety information from the output unit 153.

The remote control unit 163 remotely controls the flight operation of the drone 11. For example, the remote control unit 163 generates an operation command or control parameter for remotely controlling the drone 11 on the basis of input information, own-device information, and safety information and transmits the generated command or parameter to the drone 11 via the communication unit 154.

The output unit 153 includes various output devices that output visual information, auditory information, or haptic sensation information. For example, the output unit 153 includes a display device, an audio output device, or a haptics device. The output unit 153 outputs various types of information under the control of the output control unit 162.

The communication unit 154 includes various communication devices and performs wireless communication with a different device using a predetermined communication method. For example, the communication unit 154 directly performs wireless communication with the drone 11A and the mobile device 13.

The storage unit 155 includes, for example, a non-volatile memory and stores various types of information necessary for the processing of the controller 12.

### Configuration Example of Mobile Device 13

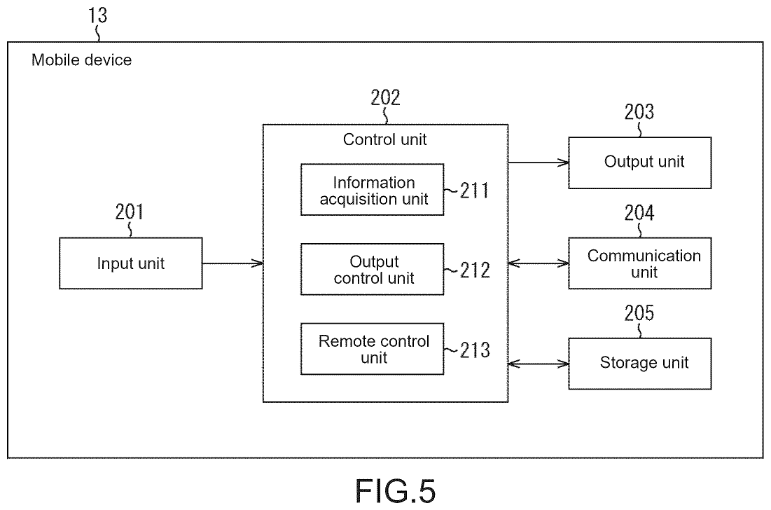

FIG. 5 shows a configuration example of a function of the mobile device 13.

The mobile device 13 includes an input unit 201, a control unit 202, an output unit 203, a communication unit 204, and a storage unit 205.

The input unit 201 includes various input devices and operation devices and is used to input various types of information and operate the mobile device 13. The input unit 201 supplies input information input using the input device or the operation device to the control unit 202.

The control unit 202 includes a processor such as a CPU, a memory, and the like. The control unit 202 executes a predetermined program to control the respective units of the mobile device 13 and execute various types of processing. The control unit 202 includes an information acquisition unit 211, an output control unit 212, and a remote control unit 213.

The information acquisition unit 211 acquires various types of information from the outside via the communication unit 204. For example, the information acquisition unit 211 acquires own-device information from the drone 11A. For example, the information acquisition unit 161 acquires safety information from the management server 14.

The output control unit 212 controls an output of various types of information from the output unit 203 (e.g., visual information, auditory information, and haptic sensation information). For example, the output control unit 212 controls an output of safety information from the output unit 203.

The remote control unit 213 remotely controls the flight operation of the drone 11. For example, the remote control unit 213 generates an operation command or control parameter for remotely controlling the drone 11 on the basis of input information, own-device information, and safety information and transmits the generated command or parameter to the drone 11 via the communication unit 204.

The output unit 203 includes various output devices that output visual information, auditory information, or haptic sensation information. For example, the output unit 203 includes a display device, an audio output device, or a haptics device. The output unit 203 outputs various types of information under the control of the output control unit 212.

The communication unit 204 includes various communication devices and performs wireless communication with a different device using a predetermined communication method. For example, the communication unit 204 communicates with the drone 11A, the management server 14, the information delivery server 15, the registered aircraft inquiry server 16, and the like via the network 31. For example, the communication unit 204 directly performs wireless communication with the controller 12.

The storage unit 205 includes, for example, a non-volatile memory and stores various types of information necessary for the processing of the mobile device 13.

### Configuration Example of Management Server 14

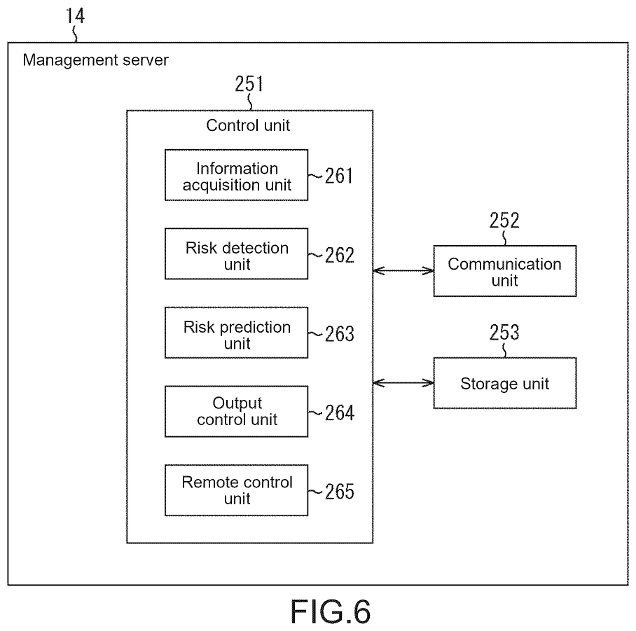

FIG. 6 shows a configuration example of a function of the management server 14.

The management server 14 includes a control unit 251, a communication unit 252, and a storage unit 253.

The control unit 251 includes a processor such as a CPU, a memory, and the like. The control unit 251 executes a predetermined program to control the respective units of the management server 14 and execute various types of processing. The control unit 251 includes an information acquisition unit 261, a risk detection unit 262, a risk prediction unit 263, an output control unit 264, and a remote control unit 265.

The information acquisition unit 261 acquires various types of information from the outside via the communication unit 252. For example, the information acquisition unit 261 acquires own-device information and another-device information from the drone 11A. For example, the information acquisition unit 161 acquires delivery information from the information delivery server 15. For example, the information acquisition unit 161 acquires registration information of each drone 11 from the registered aircraft inquiry server 16. For example, the information acquisition unit 261 acquires an operation history of the drone 11 of each user from the user operation history DB 18. For example, the information acquisition unit 261 acquires an operation history of each drone 11 from the aircraft operation history DB 19. For example, the information acquisition unit 261 acquires a risk history of each point from the risk history DB 20.

The risk detection unit 262 detects a risk of the flight area of the drone 11A on the basis of own-device information, another-device information, delivery information from the information delivery server 15, an operation history of the drone 11 of the user, an operation history of the drone 11A, a risk history of each point, and the like. The risk detection unit 262 generates a current risk map on the basis of the result of detecting a risk of a flight area.

The risk prediction unit 263 predicts a risk of the flight area of the drone 11A on the basis of the result of detecting a risk of the flight area of the drone 11A, delivery information from the information delivery server 15, a risk history of each point, and the like. The risk prediction unit 263 generates a future risk map on the basis of the result of predicting a risk of a flight area.

The output control unit 264 generates safety information relating to the safety of the flight area of the drone 11A on the basis of the detection result and prediction result of a flight history of the drone 11A. The output control unit 264 transmits the safety information to a different device via the communication unit 252 and the network 31 to control an output of safety information by the different device (e.g., the drone 11A, the controller 12, and the mobile device 13).

The remote control unit 265 remotely controls the flight operation of the drone 11. For example, the remote control unit 265 generates an operation command or control parameter for remotely controlling the drone 11 on the basis of own-device information and safety information and transmits the generated command or parameter to the drone 11 via the communication unit 252.

The communication unit 252 includes various communication devices and communicates with a different device using a predetermined communication method. For example, the communication unit 252 communicates with the drone 11, the information delivery server 15, the registered aircraft inquiry server 16, the user operation history DB 18, the aircraft operation history DB 19, the risk history DB 20, and the like via the network 31.

### Processing of Flight Management System 1

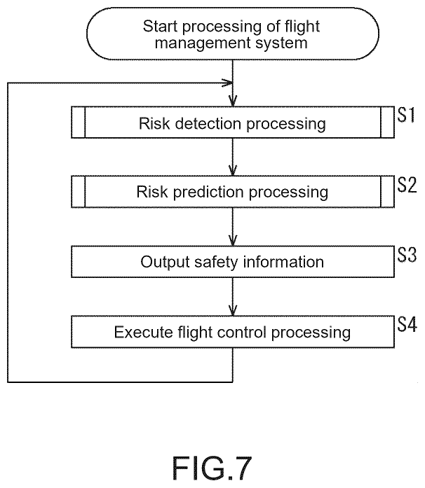

Next, processing of the flight management system 1 will be described with reference to the flowchart of FIG. 7.

For example, this processing starts when the power source of the drone 11A is turned on and ends when the power source is turned off.

In Step S1, the flight management system 1 executes risk detection processing.

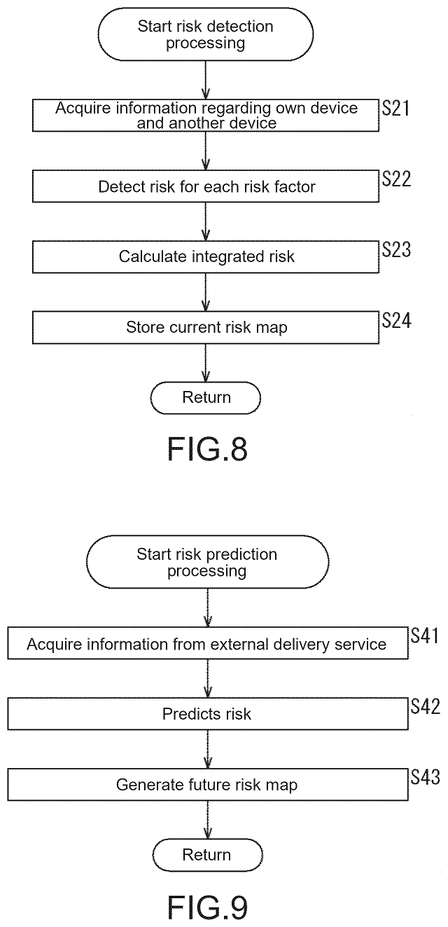

Now, details of the risk detection processing will be described with reference to the flowchart of FIG. 8.

In Step S21, the drone 11A acquires information regarding an own device and another device.

Specifically, the own-device information detection unit 112 detects a geomagnetic state, a wind state (e.g., a wind direction and a wind speed), and illuminance around the own device on the basis of sensor data from the sensor unit 101.

The GNSS signal reception unit 102 of the drone 11A receives a GNSS signal from a GNSS satellite and supplies the received signal to the control unit 103. The own-device information detection unit 112 detects the current position (a latitude, a longitude, and an altitude) and posture of the own device on the basis of the GNSS signal. Further, the own-device information detection unit 112 detects a GNSS signal reception state. The GNSS signal reception state includes, for example, the number of observation satellites and a C/N (carrier-to-noise ratio) of the GNSS signal.

The own-device information detection unit 112 detects a communication state of wireless communication on the basis of information from the communication unit 106. The communication state of wireless communication includes, for example, the strength and S/N ratio of the transmission signal from the controller 12, the Wi-Fi access point with which communication is possible, and the RSSI (Received Signal Strength Indicator) of the reception signal from the access point.

The own-device information detection unit 112 detects, for example, the travelling direction (orientation) and the speeds in the vertical direction and the horizontal direction of the drone 11A on the basis of sensor data from the sensor unit 101 and information from the flight mechanism 104.

The own-device information detection unit 112 determines the aircraft status of the own device on the basis of the above detection results or the like. The aircraft status is classified as, for example, either normal or emergency. The emergency indicates that, for example, an emergency has occurred.

The own-device information detection unit 112 generates own-device information that is information relating to the own device. The own-device information includes, for example, the current date and time, information relating to a surrounding environment of the own device, information relating to the state of the own device, and information relating to the own device.

The information relating to a surrounding environment of the own device includes, for example, the geomagnetic state, wind state, illuminance, communication state of wireless communication, and GNSS signal reception state around the own device, and the current position of the own device.

The information relating to the state of the own device includes, for example, the travelling direction (orientation), speeds in the vertical direction and the horizontal direction, attitude, and aircraft status of the own device.

The information relating to the own device includes, for example, information relating to the aircraft of the own device and registration information of the own device. The information relating to the aircraft of the own device includes, for example, the aircraft type of the own device. The aircraft type of the own device includes, for example, UA type and EU class/category. The registration information of the own device includes, for example, RID (remote ID) of the own device, a serial number, an operator ID of an operator of the drone 11A.

The own-device information detection unit 112 transmits the own-device information to the controller 12 via the communication unit 106. The information acquisition unit 161 of the controller 12 receives the own-device information from the drone 11A via the communication unit 154.

The own-device information detection unit 112 transmits the own-device information to the mobile device 13 via the communication unit 106 and the network 31. The information acquisition unit 211 of the mobile device 13 receives the own-device information from the drone 11A via the network 31 and the communication unit 204.

The own-device information detection unit 112 transmits the own-device information to the management server 14 via the communication unit 106 and the network 31. The information acquisition unit 261 of the management server 14 receives the own-device information from the drone 11A via the network 31 and the communication unit 252.

Further, the information acquisition unit 111 of the drone 11A receives another-device information relating to each drone 11B from the drone 11B with which direct communication is possible via the communication unit 106. The another-device information includes, for example, information relating to each drone 11B, which is similar to the above-mentioned own-device information.

The own-device information detection unit 112 transmits the another-device information to the management server 14 via the communication unit 106 and the network 31. The information acquisition unit 261 of the management server 14 receives the another-device information from the drone 11A via the network 31 and the communication unit 252.

Note that, for example, in the case where the communication state with the network 31 is poor, the drone 11A may transmits the own-device information and another-device information to the management server 14 via the controller 12, the mobile device 13, and the network 31.

In Step S22, the risk detection unit 262 detects a risk for each risk factor. For example, the risk detection unit 262 detects risks for the geomagnetic state, wind state, illuminance, GNSS signal reception state, and communication state of wireless communication.

Specifically, for example, the risk detection unit 262 calculates the risk for each risk factor around the drone 11A on the basis of the own-device information. For example, the risk for each risk factor is normalized within a range from 0.0 to 1.0 and is set to have a higher value as the risk increases.

For example, the geomagnetic risk that is a risk based on the geomagnetic state is calculated by the difference between the norm value of the geomagnetism in the three-axis direction detected by the drone 11A and the reference value. The reference values is set on the basis of, for example, “Maps of Magnetic Elements from the WMM2020” published by NOAA (National Oceanic and Atmospheric Administration).

For example, the wind risk that is a risk based on the wind state is calculated by the following formula (1) in the case where the wind speed detected by the drone 11A satisfies the following relationship: th1<wind speed≤th0.

$$Wind risk = 1. - 1. / ( ( wind speed - th 1 ) + 1. ) \qquad ( 1 )$$

Note that in the case where the following relationship: th0<wind speed is satisfied, the wind risk is set to 1.0 (very dangerous). In the case where the following relationship: wind speed≤th1 is satisfied, the wind risk is set to 0.0 (safe).

For example, the GNSS risk that is a risk based on the GNSS signal reception state is calculated by the following formula (2).

$$GNSS risk = α \times ( C / N ) + ( 1 - α ) \times number of observation satellites \qquad ( 2 )$$

α represents a coefficient and is set to a value of 0 or more and less than 1. C/N represents C/N of the GNSS signal received by the drone 11A.

For example, the wireless communication risk that is a risk based on the communication state of wireless communication is calculated by normalizing the RSSI of the reception signal of wireless communication detected by the drone 11A.

The risk detection unit 262 calculates the risk for each risk factor around each drone 11B on the basis of the another-device information of each drone 11B by a similar method.

In this way, the risk for each risk factor of each of the drone 11A and the respective drones 11B at the current position at a current time t is calculated.

In Step S23, the risk detection unit 262 calculates the integrated risk. For example, the risk detection unit 262 calculates a weighted average of risks for each risk factor around the drone 11A as the integrated risk around the drone 11A.

Note that the weight for the risk for each risk factor in the weighted average is set by, for example, an experiment. Further, in the case where the aircraft status of the drone 11A is emergency (in the case where an emergency has occurred in the drone 11A), for example, the integrated risk is set to 1.0 (very dangerous).

The risk detection unit 262 calculates the integrated risk around each drone 11B by a similar method.

In this way, the integrated risk of each of the drone 11A and the respective drones 11B at the current position at the current time t is calculated.

In Step S24, the management server 14 generates a current risk map. Specifically, for example, the information acquisition unit 261 of the management server 14 acquires a risk history of each point in the three-dimensional space including the flight area of the drone 11A from a predetermined time ago to a time t−1 that is one before the current time t (hereinafter, referred to as map space) from the risk history DB 20 via the communication unit 252 and the network 31.

The risk detection unit 262 divides the map space into a plurality of voxels for each predetermined units. The risk detection unit 262 accumulates, for each voxel and each risk factor, the risk at a point included in each voxel from the predetermined time ago to the time t to calculate the risk for each risk factor of each voxel. At this time, the risk detection unit 262 accumulates the risk using an attenuation function such that the value of the risk is attenuated as the detection time is earlier. The risk detection unit 262 calculates the integrated risk of each voxel by accumulating the integrated risk of the point included in each voxel by a similar method.

In this way, the risk map at the current time t is generated. That is, the risk map indicates the risk and the integrated risk in units of a plurality of voxels obtained by dividing the map space. In other words, the risk map indicates the spatial distribution of risks for each risk factor and the integrated risks in the map space.

The risk detection unit 262 stores, in the risk history DB 20, the information indicating the risk for each risk factor at each position at the current time t and the integrated risk and the risk map at the time t via the communication unit 252 and the network 31.

After that, the risk detection processing ends.

With reference to FIG. 7 again, in Step S2, the management server 14 executes risk prediction processing.

Now, details of the risk prediction processing will be described with reference to the flowchart in FIG. 9.

In Step S41, the information acquisition unit 261 of the management server 14 acquires information from an external delivery service. For example, the information acquisition unit 261 acquires delivery information to be used for predicting the risk at each point from the information delivery server 15 via the communication unit 252 and the network 31. The delivery information to be acquired includes, for example, weather information delivered by the Japan Meteorological Agency or NOAA.

In Step S42, the risk prediction unit 263 of the management server 14 predicts a risk.

For example, the risk prediction unit 263 predicts a risk for each risk factor at each point in the future and an integrated risk using a learning model on the basis of the delivery information acquired by the processing of Step S41 and the risk history of each point from the predetermined time ago to the current time t.

At this time, the risk prediction unit 263 may predict, for example, a risk of each point at a time t+Δt, which is Δt after the current time t. Alternatively, the risk prediction unit 263 may predict, for example, a risk of each point during a period of a length T from the time t+Δt to a time t+Δt+T.

Note that the learning model is generated by machine learning offline in advance. For example, SVM (Support Vector Machine) or supervised learning using a neural network is used to train the learning model.

For example, the learning model is generated by performing machine learning using delivery information at a certain point and a risk history for a predetermined period as learning data and a risk history at the point Δt after the period as teaching data.

Alternatively, for example, the learning model is generated by performing machine learning using delivery information at a certain point and a risk history for a predetermined period as learning data and a risk history at the point for a period of a predetermined length T Δt after the predetermined period as teaching data.

Note that a different learning model may be used for each type of risk or the same learning model may be used. In the former case, for example, a learning model for a geomagnetic risk, a learning model for a wind risk, and a learning model for an integrated risk are individually generated and used. In the latter case, one learning model is generated and the one learning model is used to predict the risk for each risk factor and the integrated risk.

In Step S43, the risk prediction unit 263 generates a future risk map. Specifically, the risk prediction unit 263 generates a future risk map on the basis of the predicted value of the risk of each point by processing similar to that of Step S24 in FIG. 8.

Note that, for example, in the case where the risk at each time within a predetermined period has been predicted, a plurality of risk maps at each time within the period is generated. Meanwhile, for example, in the case where the risk at a time a predetermined time after the current time has been predicted, a risk map at the time is generated.

The risk prediction unit 263 stores the future risk map in the risk history DB 20 via the communication unit 252 and the network 31.

After that, the risk prediction processing ends.

With reference to FIG. 7 again, in Step S3, the flight management system 1 outputs safety information.

For example, the output control unit 264 of the management server 14 generates safety information including information relating to the safety of the flight area of the drone 11A on the basis of the past and current risks of each point and the past and current future risk maps. The safety information includes, for example, safety presentation information for presenting the current and future risk maps and the information relating to the safety of the flight area of the drone 11A to the user.

The output control unit 264 transmits the safety information to the drone 11A and the mobile device 13 via the communication unit 252 and the network 31.

The information acquisition unit 111 of the drone 11A receives the safety information from the management server 14 via the network 31 and the communication unit 106. The output control unit 114 of the drone 11 controls the output of safety information from the output unit 105 on the basis of the safety presentation information included in the safety information, as necessary.

The information acquisition unit 211 of the mobile device 13 receives the safety information from the management server 14 via the communication unit 204 and the network 31. The output control unit 212 of the mobile device 13 controls the output of safety information from the output unit 203 on the basis of the safety presentation information included in the safety information, as necessary.

Further, the information acquisition unit 211 of the mobile device 13 transmits the safety information to the controller 12 via the communication unit 204.

The information acquisition unit 161 of the controller 12 receives the safety information from the mobile device 13 via the communication unit 154. The output control unit 162 of the controller 12 controls the output of safety information from the output unit 153 on the basis of the safety presentation information included in the safety information, as necessary.

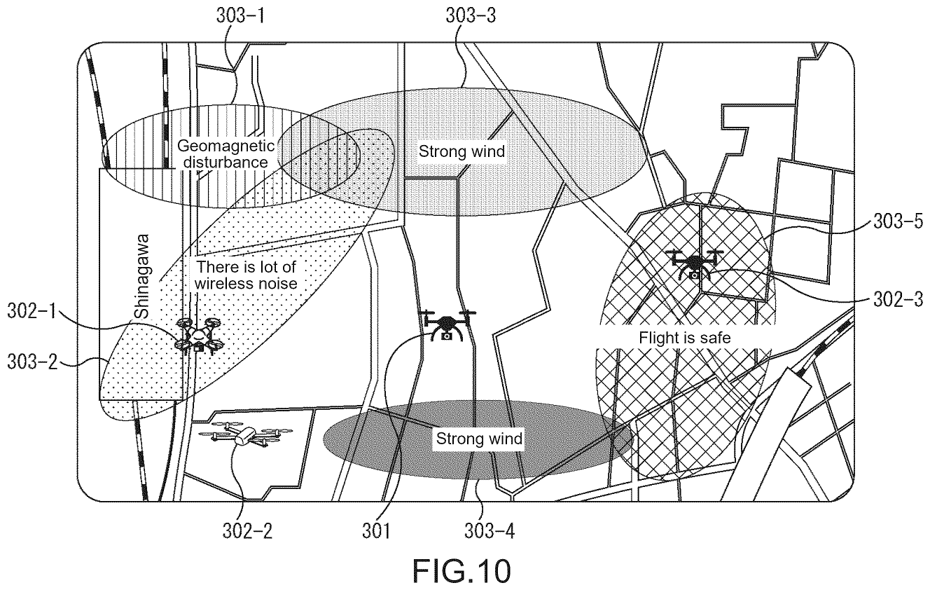

Now, an example of an output of safety information will be described with reference to FIG. 10 to FIG. 15.

First, an example of a screen of safety information displayed on a display device included in the output unit 203 of the mobile device 13 will be described with reference to FIG. 10 to FIG. 13.

In the example of FIG. 10, the current risk map (spatial distribution of risks) is superimposed on the map including the flight area of the drone 11A. Specifically, a drone-shaped icon 301, drone-shaped icons 302-1 to 302-3, and areas 303-1 to 303-5 are superimposed on the map.

Note that hereinafter, in the case where there is no need to individually distinguish between the icons 302-1 to 302-3, they will be referred to simply as an icon 302. Hereinafter, in the case where there is no need to individually distinguish between the areas 303-1 to 303-5, they will be referred to simply as an area 303.

The icon 301 indicates the current position of the own device (drone 11A). Each icon 302 indicates the current position of another device (drone 11B) around the own device. Note that the designs of the icon 301 and the icon 302 may be changed depending on, for example, the type of corresponding drone 11A or drone 11B.

Each area 303 indicates the position of a safe area or dangerous area. Here, the safe area is an area where safety has been ensured. The dangerous area is, for example, an area where the risk for at least one risk factor has a predetermined threshold value or more.

Further, information indicating the characteristics of the area 303 is displayed in each area 303. Here, the characteristics of the area 303 include, for example, whether it is a safe area or a dangerous area, a risk factor in the area 303, and the like.

Specifically, the area 303-1 indicates the position of a dangerous area where geomagnetic disturbances have occurred. The area 303-2 indicates the position of a dangerous region where there is a lot of noise in wireless communication. Each of the area 303-3 and the area 303-4 indicates the position of a dangerous area where the wind is strong. The area 303-5 indicates the position of an area where another device is capable of flying safely.

The display mode (e.g., color or pattern) of each area 303 changes depending on, for example, the characteristics of the area. For example, the display mode of each area 303 changes depending on whether it is a safe area or a dangerous area or the risk factor. Further, for example, the display mode (e.g., color shade) of the area 303 having the same risk factor changes depending on the risk. Further, the display mode of the area 303 where a plurality of risk factors is superimposed each other changes such that the area stands out more than the other areas (e.g., the color becomes darker or brighter).

Note that, for example, only the area of the characteristics selected by the user may be displayed. For example, only the area 303-1 where the risk factor is the geomagnetic state and the area 303-3 and the area 303-4 where the risk factor is the wind state may be displayed by the user's selection.

Further, for example, the dangerous area may be displayed without distinguishing between risk factors. In this case, for example, the dangerous area based on the integrated risk may be displayed instead of the dangerous area for each risk factor.

Further, for example, not only the current risk map but also the past or future risk map may be superimposed on the map. For example, the risk map at the date and time specified by the user may be superimposed on the map. For example, risk maps at each date and time from the past to the future may be switched and displayed on the map at predetermined time intervals such that the time series transition of the risk map is presented to the user.

This allows the user to check the safety of each point within the flight area of the own device easily and in detail.

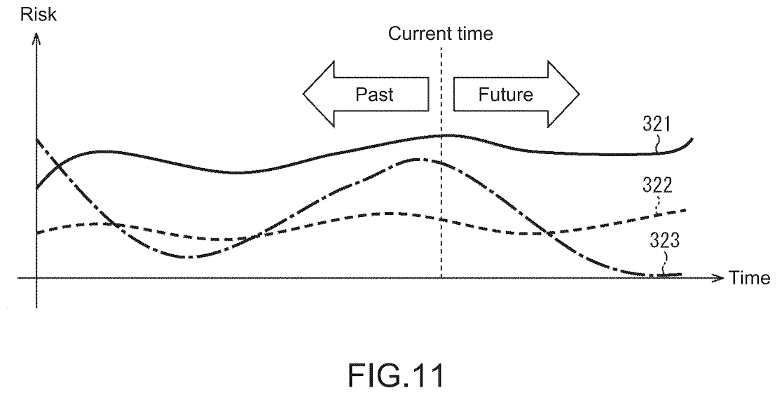

In the example shown in FIG. 11, the time series transition of the risk for each risk factor in a predetermined area and the integrated risk is shown in a graph. That is, the time series transition of the detection value of each of the past and current risks for each risk factor in a predetermined area and the integrated risk and the predicted value of each of the future risk and the integrated risk is shown in a graph.

Specifically, the horizontal axis of the graph indicates the time, and the vertical axis indicates the risk. For example, a curve 321 indicates the time series transition of the integrated risk. A curve 322 indicates the time series transition of the GNSS risk. A curve 323 indicates the time series of the wind risk.

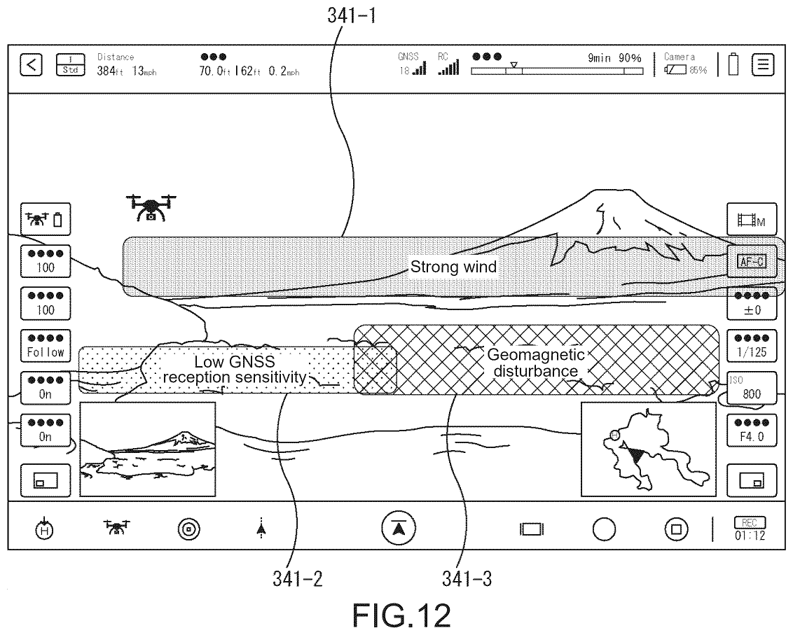

For example, the transition of the risk of voxel including the position specified by the user on the screen in FIG. 10 may be displayed by the graph of FIG. 11. Alternatively, for example, the transition of the risk of voxel including the current position of the own device may be displayed by the graph of FIG. 12.

Note that, for example, the user may be allowed to select the risk factor or period of the risk displayed in the graph of FIG. 11.

Further, for example, the time series transition of the average value of the risk for each risk factor in the flight area of the drone 11 and the integrated risk may be displayed.

This allows the user to check the time series transition of the risk of the flight area of the drone 11 easily and in detail.

In the example shown in FIG. 12, the current risk map (information indicating the spatial distribution of risks) is superimposed on an image (moving image) of the surroundings of the drone 11A taken by the drone 11A. Specifically, areas 341-1 to 341-3 are superimposed on the image.

Note that hereinafter, in the case where there is no need to individually distinguish between the areas 341-1 to 341-3, they will be referred to simply as an area 341.

Each area 341 indicates the position of a safe area or a dangerous area similarly to each area 303 in FIG. 11. Further, information indicating the characteristics of the area 341 are displayed on each area 341 similarly to each area 303 in FIG. 11.

Specifically, the area 341-1 indicates the position of a dangerous area where the wind is strong. The area 341-2 indicates the position of a dangerous area where the reception sensitivity of a GNSS signal is low. The area 341-3 indicates the position of a dangerous area where geomagnetic disturbances have occurred.

The display mode of each area 341 changes depending on, for example, the characteristics of the area 341 similarly to the display mode of each area 303 in FIG. 11.

Note that, for example, only the area of the characteristics selected by the user may be displayed.

Further, for example, the dangerous area may be displayed without distinguishing between risk factors.

Further, for example, not only the current risk map but also the past or future risk map may be superimposed on the image. For example, the risk map at the time specified by the user may be superimposed on the image. For example, risk maps at each date and time from the past to the future may be switched and displayed on the image at predetermined time intervals such that the time series transition of the risk map is presented to the user.

This allows the user to recognize the safety of the flight area of the own device in the actual scene easily and in detail.

Note that although menus and operation areas are displayed above and below the image in FIG. 12 and icons indicating the state of the drone 11A and the like are superimposed on the image, the detailed description thereof will be omitted.

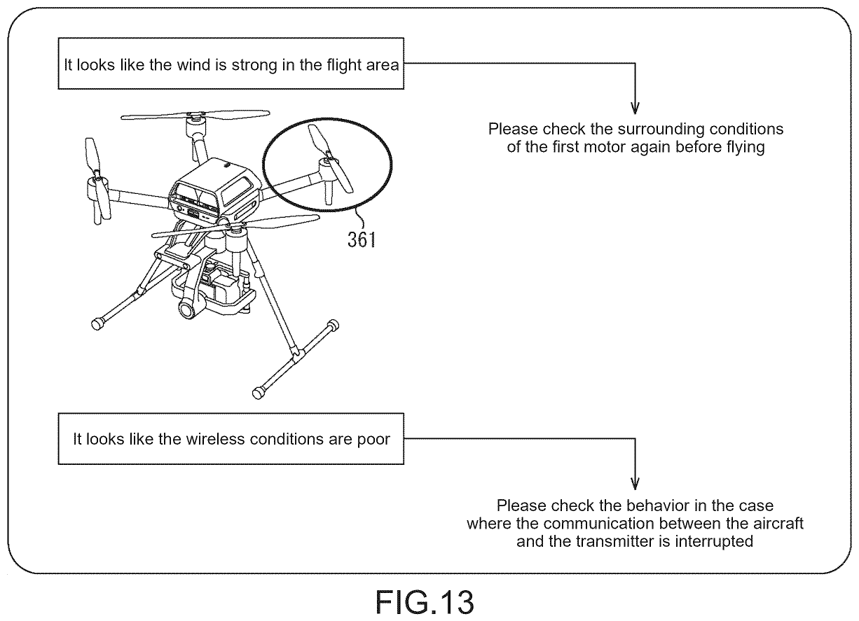

FIG. 13 shows a display example of the instruction to the user before flying the drone 11A. Specifically, risk factors of the flight area of the drone 11A and information relating to the countermeasures against the risk factors are displayed.

The countermeasures against the risk factors are assumed to be, for example, the inspection of the aircraft of the drone 11A, the operation specifications of the drone 11A when a trouble occurs, and checking the operation method.

Specifically, in the example shown in FIG. 13, since the wind is strong in the flight area of the own device, information for urging to check the surrounding conditions of the first motor of the drone 11A again before flying the drone 11A is displayed. Further, a frame 361 indicates the position of the first motor of the drone 11A.

Further, since the communication state of wireless communication (wireless conditions) is poor, information for urging to check the behavior of the drone 11A in the case where the communication between the aircraft of the drone 11A and the transmitter (controller 12) is interrupted in the manual or the like is displayed.

This allows the user to check risk factors in the flight area before flying the drone 11A and take appropriate countermeasures.

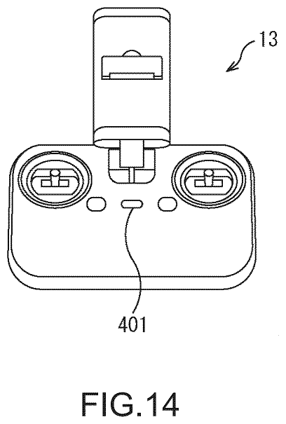

Next, an example of an output of safety information from the controller 12 will be described with reference to FIG. 14.

FIG. 14 shows a configuration example of the appearance of the controller 12.

The controller 12 includes an LED 401. The LED 401 constitutes part of the output unit 153.

For example, the output control unit 162 causes the LED 401 to emit light in a color or pattern corresponding to the risk factor. Note that the output control unit 162 may change the brightness or the like of the LED 401 depending on the risk.

Further, for example, the output control unit 162 vibrates the controller 12 with a vibration pattern corresponding to the risk factor. For example, the output control unit 162 causes the output unit 153 to output a sound pattern corresponding to the risk factor.

This allows the user to recognize, for example, that there is a dangerous area around the drone 11A and the risk factor without looking at the mobile device 13.

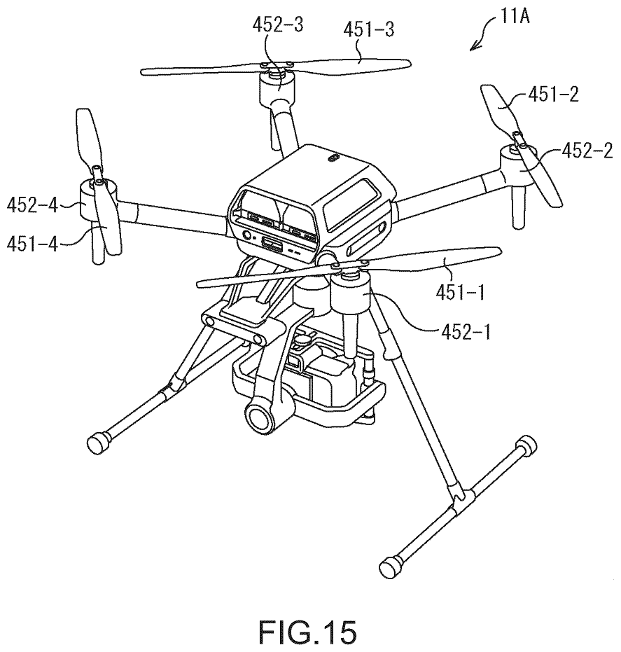

Next, an example of an output of safety information from the drone 11A will be described with reference to FIG. 15.

FIG. 15 shows a configuration example of the appearance of the drone 11A.

The drone 11A includes LEDs 452-1 to 452-4 below propellers 451-1 to 451-4. The LEDs 452-1 to 452-4 constitute part of the output unit 105.

Note that in the case where there is no need to individually distinguish between the LEDs 452-1 to 452-4, they will be referred to simply as the LED 452.

For example, each LED 452 emits light in a color or pattern corresponding to the risk factor under the control of the output control unit 114. Note that the output control unit 114 may change the brightness or the like of each LED 452 depending on the risk.

Further, in the case where the drone 11A is about to take off, for example, the output control unit 114 causes the output unit 105 to output a sound pattern corresponding to the risk factor.

This allows the user to recognize, for example, that there is a dangerous area around the drone 11A and the risk factor without looking at the mobile device 13.

With reference to FIG. 7 again, in Step S4, the flight management system 1 executes flight control processing.

For example, the operation control unit 113 of the drone 11A executes, as necessary, risk countermeasures by controlling the flight operation of the drone 11 on the basis of the own-device information acquired in the processing of Step S21, the risk map for each risk factor, the risk map of the integrated risk, or the like.

For example, in the case where the risk around the drone 11A is high, the operation control unit 113 restricts the flight operation, changes the conditions for initiating an emergency landing or RTH (Return To Home), or executes an emergency landing or RTH. The restriction of the flight operation includes, for example, the restriction of at least one of the maximum speed, the flight altitude, and the maximum change amount of attitude of the drone 11A.

For example, the operation control unit 113 sets a geofence for an area where the risk has a predetermined threshold value or more in the current and future risk maps and controls the drone 11A so as not to enter the geofence.

For example, in the case where the drone 11A flies in an area where there is a possibility that the accuracy of a specific sensor decreases in the current risk map, the operation control unit 113 restricts the use of the target sensor. For example, the use of a geomagnetic sensor is restricted in an area where the geomagnetism is disturbed. For example, the use of an image sensor is restricted in an area where the illuminance is low.

Specifically, for example, the operation control unit 113 stops the user of the target sensor until the drone 11A leaves the area. For example, the operation control unit 113 reduces the weighting of the target sensor during sensor fusion using an EKF (extended Kalman filter) or the like until the drone 11A leaves the area.

For example, in the case where the drone 11A is flying in an area where the communication state of wireless communication is poor, the operation control unit 113 reduces the transfer rate of moving images taken by the sensor unit 101 in order to stabilize communication.

For example, the operation control unit 113 sets a route such that the drone 11 flies through an area where the risk is low in the risk map.

When executing a risk countermeasure for the drone 11A, the operation control unit 113 transmits risk countermeasure information indicating the content of the risk countermeasure to the mobile device 13 via the communication unit 106 and the network 31.

The information acquisition unit 211 of the mobile device 13 receives the risk countermeasure information from the drone 11A via the network 31 and the communication unit 204.

The output control unit 212 of the mobile device 13 causes the output unit 203 to output, as necessary, information relating to the risk countermeasure for the drone 11A on the basis of the safety presentation information and the risk countermeasure information.

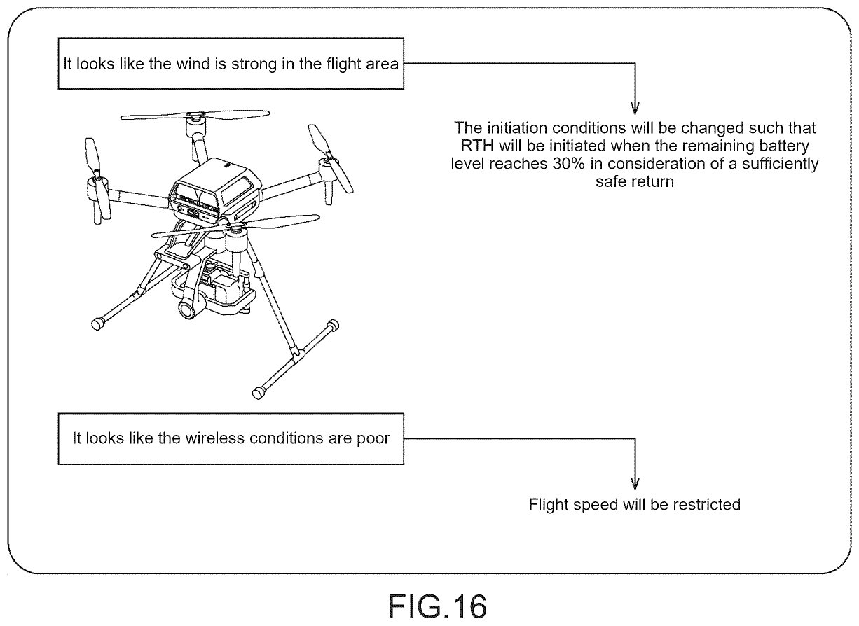

FIG. 16 shows an example of a screen displayed on the display device included in the output unit 214 of the mobile device 13 at this time.

In this example, since the wind is strong in the flight area of the drone 11A, a message indicating that the initiation conditions will be changed such that RTH will be initiated when the remaining battery level of the drone 11A reaches 30% in consideration of a sufficiently safe return is displayed.

Further, since the wireless conditions around the drone 11A (communication state of wireless communication) are poor, a message indicating that the flight speed of the drone 11A will be restricted is displayed.

Note that, for example, in the case where the communication state of wireless communication is poor, the output unit 214 may output information for urging to use the controller 12 having a longer communication range than the mobile device 13 or perform the operation near the drone 11A.

Note that although an example in which the user is notified of that a risk countermeasure will be executed is shown here, an inquiry for the user about whether or not to execute a risk countermeasure before executing the risk countermeasure may be made. For example, in the case where the user permits the risk countermeasures, the drone 11A may then execute the risk countermeasure.

This allows the drone 11A to avoid danger and fly safely. Further, the user can easily recognize the danger of the flight area and the risk countermeasure to be executed against it.

After that, the processing returns to Step S1 and the processing of Step S1 and subsequent Steps is executed.

In this way, the user can easily check the safety of the flight area of the drone 11 before and during flight. This allows the drone 11 to fly more safely.

### 2. Modified Example

A modified example of the above-mentioned embodiment of the present technology will be described.

### Modified Example Relating to Risk

For example, the risk detection unit 262 may detect the risk of the flight area on the basis of the history of past accidents. For example, the risk detection unit 262 may set a high risk near a point where an accident occurred in the past.

For example, a drone having an aircraft weight of 250 g and a drone having an aircraft weight of 25 kg have different risks for wind. In this regard, for example, the risk detection unit 262 may calculate the risk on the basis of the characteristics of the own device. The characteristics of the own device include, for example, a model, a manufacturer, a size, a weight, specifications, a method (e.g., VTOL (Vertical Take-Off and Landing aircraft) or multicopter), and an aircraft type (e.g., class UA type or EU class/category).

For example, the risk detection unit 262 may preferentially use another-device information of another device having characteristics similar to those of the own device (hereinafter, referred to as another similar device) to calculate the risk. For example, the risk detection unit 262 may calculate the risk using only another-device information of another similar device. For example, the risk detection unit 262 may calculate the risk by increasing the weighting of another-device information of another similar device.

For example, the risk detection unit 262 may calculate the probability of occurrence of a trouble with the aircraft of the own device on the basis of the maintenance status of the own device, the repair history, the operating organization, or the like, and may calculate the risk on the basis of the probability of occurrence of a trouble with the aircraft.

For example, the risk detection unit 262 may calculate the risk on the basis of the position or movement of another device. For example, the risk detection unit 262 may set a high risk near the position where a large drone 11B is flying at high speed.

For example, the risk detection unit 262 may calculate the risk on the basis of the user's operation experience of the drone. For example, for the same environmental conditions, the risk may be set lower as the user has more operation experience and set higher as the user has less operation experience.

The number of risk levels can be arbitrarily set. For example, the number of risk levels can be set to two levels of safe or dangerous, three levels of safe, normal, or dangerous, or four or more levels.

The risk map does not necessarily need to be a map of a three-dimensional space of latitude, longitude, and altitude, and may be, for example, a map of a two-dimensional space of latitude and longitude.

### Modified Example Relating to Risk Countermeasure

For example, the operation control unit 113 of the drone 11 may execute a risk countermeasure on the basis of the user's operation experience of the drone. For example, in the case where the user has a long operation experience of the drone, the operation control unit 113 may set a high threshold value for the risk to be used to determine whether or not to execute a risk countermeasure (hereinafter, referred to as a risk countermeasure threshold value) (make it difficult to execute a risk countermeasure) or execute a risk countermeasure that requires an advanced operation. For example, in the case where the user has little operation experience of the drone, the operation control unit 113 may set a low risk countermeasure threshold value (make it easier to execute a risk countermeasure) or execute a safer risk countermeasure.

For example, the operation control unit 113 may execute a risk countermeasure on the basis of the characteristics of the own device.

For example, the operation control unit 113 may calculate the probability of occurrence of a trouble with the aircraft of the own device on the basis of the maintenance status of the own device, the repair history, the operating organization, or the like, and may execute a risk countermeasure on the basis of the probability of occurrence of a trouble with the aircraft. For example, the operation control unit 113 may set lower a risk countermeasure threshold value as the probability of occurrence of a trouble with the aircraft increases.

### Modified Example Relating to Method of Outputting Safety Information

For example, in the screen shown in FIG. 10, a risk map may be superimposed on the three-dimensional map.

For example, in the screen shown in FIG. 10 or the like, an altitude at which a risk map is displayed may be set, and the risk map at the set altitude may be displayed.

### Modified Example Relating to Sharing of Processes

The above-mentioned sharing of processes of the flight management system 1 is an example and can be changed as appropriate.

For example, the above-mentioned risk detection processing, risk prediction processing, and processing of generating safety information can be executed by a device other than the management server 14 or can be executed by the management server 14 and a different device in a shared manner.

Specifically, for example, the drone 11B or the mobile device 13 may execute risk detection processing on the basis of own-device information and another-device information. For example, the drone 11B or the mobile device 13 may execute risk prediction processing on the basis of a risk history and delivery information. For example, the drone 11B or the mobile device 13 may generate safety information including safety presentation information on the basis of a risk map.

For example, the controller 12, the mobile device 13, or the management server 14 may generate an operation command or control parameter on the basis of a risk map, transmits the generated command or parameter to the drone 11, and remotely control the flight operation of the drone 11 to remotely control the risk countermeasure of the drone 11.

For example, each drone 11B may transmit another-device information directly to the management server 14 via the network 31 without the drone 11A.

For example, the operation history of the drone 11A and the operation history of the user may be stored in the drone 11A, the controller 12, or the mobile device 13.

### Other Modified Examples

The present technology is applicable to, for example, an unmanned aircraft other than a drone and an unmanned flying object such as a small unmanned machine.

### 3. Others

### Configuration Example of Computer

The above-mentioned series of processes may be executed by hardware or executed by software. When the series of processes is executed by software, a program constituting the software is installed in a computer. Here, the computer includes a computer built into dedicated hardware, a general-purpose personal computer that is capable of executing various functions by installing various programs, and the like.

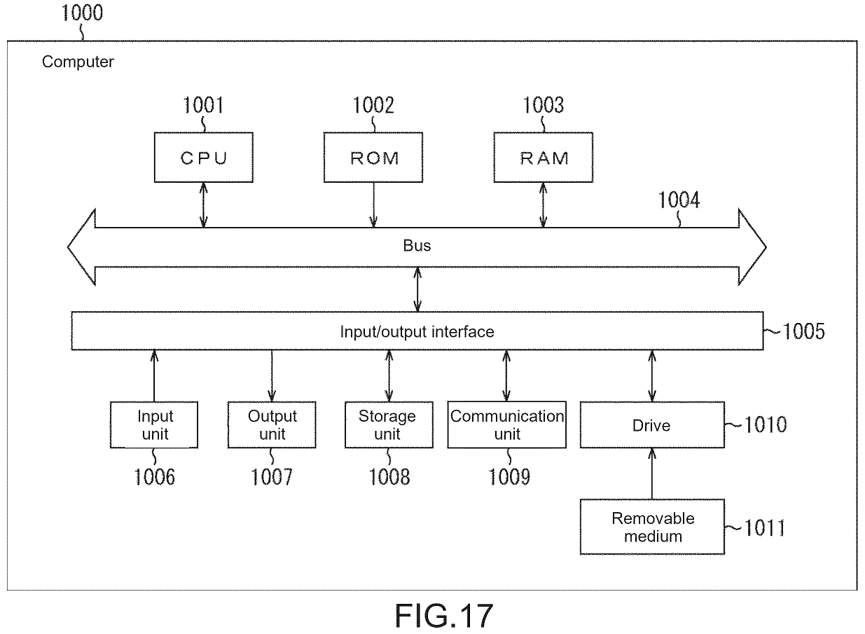

FIG. 17 is a block diagram showing a configuration example of hardware of a computer that executes the above-mentioned series of processes by a program.

In a computer 1000, a CPU (Central Processing Unit) 1001, a ROM (Read Only Memory) 1002, and a RAM (Random Access Memory) 1003 are connected to each other via a bus 1004.

An input/output interface 1005 is further connected to the bus 1004. An input unit 1006, an output unit 1007, a storage unit 1008, a communication unit 1009, and a drive 1010 are connected to the input/output interface 1005.

The input unit 1006 includes an input switch, a button, a microphone, an image sensor, and the like. The output unit 1007 includes a display, a speaker, and the like. The storage unit 1008 includes a hard disk, a non-volatile memory, and the like. The communication unit 1009 includes a network interface, and the like. The drive 1010 drives a removable medium 1011 such as a magnetic disc, an optical disc, a magneto-optical disc, and a semiconductor memory.

In the computer 1000 configured as described above, the CPU 1001 loads the program recorded in, for example, the storage unit 1008 into the RAM 1003 via the input/output interface 1005 and the bus 1004 and executes the program, thereby performing the above-mentioned series of processes.

The program executed by the computer 1000 (CPU 1001) can be recorded in, for example, the removable medium 1011 as a package medium and provided. Further, the program can be provided via a wired or wireless transmission medium such as a local area network, the Internet, and digital satellite broadcasting.

In the computer 1000, the program can be installed in the storage unit 1008 via the input/output interface 1005 by mounting the removable medium 1011 on the drive 1010. Further, the program can be received by the communication unit 1009 via a wired or wireless transmission and installed in the storage unit 1008. In addition, the program can be installed in the ROM 1002 or the storage unit 1008 in advance.

Note that the program to be executed by the computer may be a program in which processing is performed in chronological order according to the sequence described in the present specification or a program in which processing is performed in parallel or at necessary timing such as when a call is made.

Further, in the present specification, the system refers to a collection of a plurality of components (such as apparatuses and modules (parts)), and it does not matter whether all of the components are in a single housing. Therefore, a plurality of apparatuses housed in separate casings and connected to each other through a network, and a single apparatus in which a plurality of modules is housed in a single casing are each a system.

Further, the embodiment of the present technology is not limited to the above-mentioned embodiment, and various modifications can be made without departing from the essence of the present technology.

For example, the present technology may be configured as cloud computing in which a single function is shared and processed jointly by a plurality of apparatuses via a network.

Further, each Step described in the above-mentioned flowchart may be executed by one apparatus or may be shared and executed by a plurality of apparatuses.

Further, in the case where one Step includes a plurality of processes, the plurality of processes included in the one Step may be executed by one apparatus or may be shared and executed by a plurality of apparatuses.

### Examples of Configuration Combinations

The present technology may also take the following configurations.

(1) An information processing apparatus, including:
an output control unit that controls an output of safety information that is information based on first flying object information including information relating to a surrounding environment of one or more first flying objects detected by the one or more first flying objects, the safety information being information relating to safety of a flight area in which a second flying object flies.
   (2) The information processing apparatus according to (1) above, in which
the safety information includes information that indicates spatial distribution of risks in the flight area detected on a basis of the first flying object information.
   (3) The information processing apparatus according to (2) above, in which
the safety information includes an image obtained by superimposing the information that indicates spatial distribution of risks on a map.
   (4) The information processing apparatus according to (2) or (3) above, in which
the safety information includes an image obtained by superimposing the information that indicates spatial distribution of risks on an image of surroundings of the second flying object.
   (5) The information processing apparatus according to any one of (2) to (4) above, in which
the safety information includes at least one of information that indicates spatial distribution of risks for each risk factor or information that indicates spatial distribution of integrated risks obtained by integrating the risks for each risk factor.
   (6) The information processing apparatus according to (5) above, in which
the risk factor includes at least one of a geomagnetic state, a wind state, illuminance, a GNSS signal reception state, or a radio wave state of wireless communication.
   (7) The information processing apparatus according to any one of (2) to (6) above, further including
a risk detection unit that detects the spatial distribution of risks on a basis of the first flying object information.
   (8) The information processing apparatus according to (7) above, in which
the risk detection unit detects, on a basis of the first flying object information, at least one of information that indicates spatial distribution of risks for each risk factor or information that indicates spatial distribution of integrated risks obtained by integrating the risks for each risk factor.
   (9) The information processing apparatus according to (7) or (8) above, further including
a risk prediction unit that predicts spatial distribution of future risks on a basis of a detection result of the spatial distribution of risks.
   (10) The information processing apparatus according to (9) above, in which
the safety information includes information that indicates transition of the risks in the flight area from a past to a future.
   (11) The information processing apparatus according to any one of (7) to (10) above, in which
the risk detection unit detects the spatial distribution of risks further on a basis of second flying object information that includes information relating to a surrounding environment of the second flying object detected by the second flying object.
   (12) The information processing apparatus according to any one of (2) to (11) above, further including
an operation control unit that controls a flight operation of the second flying object on a basis of the spatial distribution of risks.
   (13) The information processing apparatus according to (12) above, in which
the safety information includes information that indicates spatial distribution of risks for each risk factor, and
the operation control unit controls a flight operation of the second flying object on a basis of the spatial distribution of risks for each risk factor.
   (14) The information processing apparatus according to any one of (1) to (13) above, in which
the safety information includes information that indicates a risk factor in the flight area detected on a basis of the first flying object information.
   (15) The information processing apparatus according to (14) above, in which
the safety information further includes information relating to a countermeasure against the risk factor.
   (16) The information processing apparatus according to (14) or (15) above, further including
an operation control unit that controls a flight operation of the second flying object on a basis of the risk factor in the flight area.
   (17) The information processing apparatus according to any one of (1) to (16) above, in which
the information relating to a surrounding environment of one or more first flying objects includes at least one of a geomagnetic state, a wind state, illuminance, a GNSS signal reception state, or a radio wave state of wireless communication around the one or more first flying objects.
   (18) The information processing apparatus according to any one of (1) to (17) above, in which
the first flying object information further includes at least one of information relating to a state of the first flying object or information relating to the first flying object.
   (19) The information processing apparatus according to any one of (1) to (18) above, in which
the safety information is further based on second flying object information including information relating to a surrounding environment of the second flying object detected by the second flying object.
   (20) An information processing method, including:
controlling, by an information processing apparatus, an output of safety information that is information based on flying object information including information relating to a surrounding environment of one or more first flying objects detected by the one or more first flying objects, the safety information being information relating to safety of a flight area in which a second flying object flies.

Note that the effects described in the present specification are merely examples and are not limited and other effect may be exhibited.

### REFERENCE SIGNS LIST

1 flight management system
11A, 11B-1 to 11B-n drone
12 controller
13 mobile device
14 management server
15 information delivery server
16 registered aircraft inquiry server
17 individual aircraft DB
18 user operation history DB
19 aircraft operation history DB
20 risk history DB
101 sensor unit
102 GNSS signal reception unit
103 control unit
104 flight mechanism
105 output unit
106 communication unit
111 information acquisition unit
112 own-device information detection unit
113 operation control unit
114 output control unit
152 control unit
153 output unit
154 communication unit
161 information acquisition unit
162 output control unit
163 remote control unit
202 control unit
203 output unit
204 communication unit
211 information acquisition unit
212 output control unit
   remote control unit
251 control unit
252 communication unit
261 information acquisition unit
262 risk detection unit
263 risk prediction unit
264 output control unit
265 remote control unit

1. An information processing apparatus, comprising:
an output control unit that controls an output of safety information that is information based on first flying object information including information relating to a surrounding environment of one or more first flying objects detected by the one or more first flying objects, the safety information being information relating to safety of a flight area in which a second flying object flies.

2. The information processing apparatus according to claim 1, wherein
the safety information includes information that indicates spatial distribution of risks in the flight area detected on a basis of the first flying object information.

3. The information processing apparatus according to claim 2, wherein
the safety information includes an image obtained by superimposing the information that indicates spatial distribution of risks on a map.

4. The information processing apparatus according to claim 2, wherein
the safety information includes an image obtained by superimposing the information that indicates spatial distribution of risks on an image of surroundings of the second flying object.

5. The information processing apparatus according to claim 2, wherein
the safety information includes at least one of information that indicates spatial distribution of risks for each risk factor or information that indicates spatial distribution of integrated risks obtained by integrating the risks for each risk factor.

6. The information processing apparatus according to claim 5, wherein
the risk factor includes at least one of a geomagnetic state, a wind state, illuminance, a GNSS signal reception state, or a radio wave state of wireless communication.

7. The information processing apparatus according to claim 2, further comprising
a risk detection unit that detects the spatial distribution of risks on a basis of the first flying object information.

8. The information processing apparatus according to claim 7, wherein
the risk detection unit detects, on a basis of the first flying object information, at least one of information that indicates spatial distribution of risks for each risk factor or information that indicates spatial distribution of integrated risks obtained by integrating the risks for each risk factor.

9. The information processing apparatus according to claim 7, further comprising
a risk prediction unit that predicts spatial distribution of future risks on a basis of a detection result of the spatial distribution of risks.

10. The information processing apparatus according to claim 9, wherein
the safety information includes information that indicates transition of the risks in the flight area from a past to a future.

11. The information processing apparatus according to claim 7, wherein
the risk detection unit detects the spatial distribution of risks further on a basis of second flying object information that includes information relating to a surrounding environment of the second flying object detected by the second flying object.

12. The information processing apparatus according to claim 2, further comprising
an operation control unit that controls a flight operation of the second flying object on a basis of the spatial distribution of risks.

13. The information processing apparatus according to claim 12, wherein
the safety information includes information that indicates spatial distribution of risks for each risk factor, and
the operation control unit controls a flight operation of the second flying object on a basis of the spatial distribution of risks for each risk factor.

14. The information processing apparatus according to claim 1, wherein
the safety information includes information that indicates a risk factor in the flight area detected on a basis of the first flying object information.

15. The information processing apparatus according to claim 14, wherein
the safety information further includes information relating to a countermeasure against the risk factor.

16. The information processing apparatus according to claim 14, further comprising
an operation control unit that controls a flight operation of the second flying object on a basis of the risk factor in the flight area.

17. The information processing apparatus according to claim 1, wherein
the information relating to a surrounding environment of one or more first flying objects includes at least one of a geomagnetic state, a wind state, illuminance, a GNSS signal reception state, or a radio wave state of wireless communication around the one or more first flying objects.

18. The information processing apparatus according to claim 1, wherein
the first flying object information further includes at least one of information relating to a state of the first flying object or information relating to the first flying object.

19. The information processing apparatus according to claim 1, wherein
the safety information is further based on second flying object information including information relating to a surrounding environment of the second flying object detected by the second flying object.

20. An information processing method, comprising:
controlling, by an information processing apparatus, an output of safety information that is information based on flying object information including information relating to a surrounding environment of one or more first flying objects detected by the one or more first flying objects, the safety information being information relating to safety of a flight area in which a second flying object flies.
